(19) United States
(12) Patent Application Publication
(10) Pub. No.: US 2023/0217859 A1
(43) Pub. Date: Jul. 13, 2023

(54) PNEUMATIC CUTTER WITH CONCEALED BLADE

(71) Applicant: RESEACH & BUSINESS FOUNDATION SUNGKYUNKWAN UNIVERSITY, Suwon-si (KR)

(72) Inventors: Ja Choon KOO, Suwon-si (KR); Yeo Il YUN, Suwon-si (KR); Eun Jeong SONG, Suwon-si (KR); Seon Il LEE, Suwon-si (KR); Moo Heon LEE, Suwon-si (KR)

(73) Assignee: RESEARCH & BUSINESS FOUNDATION SUNGKYUNKWAN UNIVERSITY, Suwon-si (KR)

(21) Appl. No.: 18/095,096

(22) Filed: Jan. 10, 2023

(30) Foreign Application Priority Data
Jan. 11, 2022 (KR) 10-2022-0004139

(51) Int. Cl. A01D 46/24

(52) U.S. Cl. CPC A01D 46/24; A01D 46/30

(57) ABSTRACT

A pneumatic cutter with a concealed blade includes a pouch in which an inner space filled with air is formed and which includes a variable portion configured to, upon a pneumatic pressure being applied to an inner portion of the pouch, protrude outward as the inner space expands and, in a case where the pneumatic pressure is not applied to the inner portion of the pouch, be concavely recessed inward as the inner space contracts; and a blade installed at the variable portion and configured to, upon the variable portion protruding outward due to the pneumatic pressure being applied to the inner portion of the pouch, protrude toward an object to be cut and cut the object to be cut.

### CROSS-REFERENCE TO RELATED APPLICATION

This application claims the benefit under 35 USC § 119(a) of Korean Patent Application No. 10-2022-0004139, filed on Jan. 11, 2022, the entire disclosure of which are incorporated herein by reference for all purposes.

### BACKGROUND

### Field

The present disclosure relates to a pneumatic cutter with a concealed blade that operates by pneumatic pressure and can be used to harvest crops.

### Discussion of the Background

Due to factors such as a shortage of manpower and an increase in labor costs in rural areas, automation systems have recently been introduced in the agricultural sector. However, for crops such as fruits, fruit vegetables, and root vegetables, it is difficult to apply an automation system because the marketability of the crops is greatly reduced when surfaces of the crops are damaged during the harvesting, sorting, and storing processes. In particular, in the process of harvesting fruits or fruit vegetables, due to difficulty of applying an automation system, a worker carefully holds each crop and cuts each crop with cutting scissors to harvest the crops. As a result, there is great difficulty in reducing costs of crop production and increasing efficiency of harvesting.

The related art of the present disclosure is disclosed in Korean Patent Registration No. 10-2185498 (Date of Registration: Nov. 26, 2020, Title of Disclosure: Automatic cutter for fruits harvest).

### SUMMARY

The present disclosure is directed to providing a pneumatic cutter with a concealed blade in which the blade is hidden when the pneumatic cutter approaches an object to be cut and the blade protrudes to cut the object to be cut only when the pneumatic cutter performs cutting, thus not damaging a surface of the object to be cut.

The present disclosure provides a pneumatic cutter with a concealed blade, the pneumatic cutter including: a pouch in which an inner space filled with air is formed and which includes a variable portion configured to, upon a pneumatic pressure being applied to an inner portion of the pouch, protrude outward as the inner space expands and, in a case where the pneumatic pressure is not applied to the inner portion of the pouch, be concavely recessed inward as the inner space contracts; and a blade installed at the variable portion and configured to, upon the variable portion protruding outward due to the pneumatic pressure being applied to the inner portion of the pouch, protrude toward an object to be cut and cut the object to be cut.

The pouch may further include a fixed shape portion which is not deformed even upon the pneumatic pressure being applied to the inner portion of the pouch, and in a state in which the variable portion is concavely recessed, an end of the blade may not protrude outward past a boundary portion between the variable portion and the fixed shape portion.

While the variable portion protrudes outward, the blade may move along a curved path, and the end of the blade may protrude outward past the boundary portion between the variable portion and the fixed shape portion.

In a case where the pneumatic pressure is not applied to the inner portion of the pouch in a state in which the variable portion is protruding outward, the pouch may be elastically restored so that the variable portion is concavely recessed inward.

The pouch may be made of an elastomer.

The pouch may be provided as a pair of pouches that face each other, the pair of pouches may each include the variable portion, the blade may be installed at each of the pair of variable portions, and upon a pneumatic pressure being simultaneously applied to inner portions of the pair of pouches while the object to be cut is positioned at a front center of the pair of pouches disposed to face each other, the pair of blades may overlap each other and cut the object to be cut by a shear force.

The pouch may include the variable portion as a pair of variable portions, the blade may be installed at each of the pair of variable portions, and upon a pneumatic pressure being applied to the inner portion of the pouch while the object to be cut is positioned in front of the pouch and between the pair of variable portions, the pair of blades may move along a curved path in directions approaching each other to overlap each other and cut the object to be cut by a shear force.

The pneumatic cutter may further include a cutting guide spaced apart from the variable portion so as not to come in contact with the variable portion protruding outward, and upon a pneumatic pressure being applied to the inner portion of the pouch while the object to be cut is positioned between the cutting guide and the variable portion, the blade may move toward the cutting guide and cut the object to be cut.

The blade may include, at an end portion, a concave groove portion which is concavely recessed inward, and a sharp edge may be formed on the concave groove portion.

The object to be cut may be a fruit or fruit vegetable.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIGS. 1 and 2 are cross-sectional views of a pneumatic cutter with a concealed blade according to a first embodiment of the present disclosure, wherein FIG. 1 is a view illustrating a state in which the blade is concealed, and FIG. 2 is a view illustrating a state in which the blade protrudes;

FIG. 3 is a perspective view illustrating one pouch illustrated in FIG. 1 and the blade fixed thereto; and

FIG. 4 is a cross-sectional view of a pneumatic cutter with a concealed blade according to a second embodiment of the present disclosure.

### DETAILED DESCRIPTION OF THE ILLUSTRATED EMBODIMENTS

Hereinafter, a pneumatic cutter with a concealed blade according to the present disclosure will be described in detail with reference to the accompanying drawings. The terms used herein are terms used to appropriately describe exemplary embodiments of the present disclosure and may vary according to an intention of a user or an operator or customary practice in the art to which the present disclosure pertains. Therefore, the terms should be defined on the basis of the content throughout the specification.

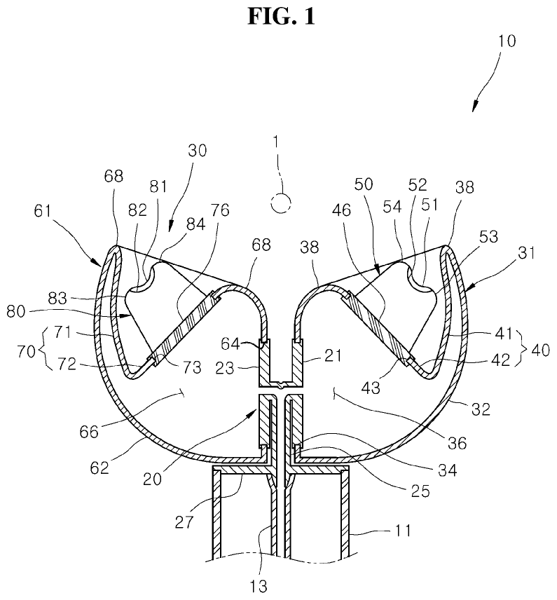

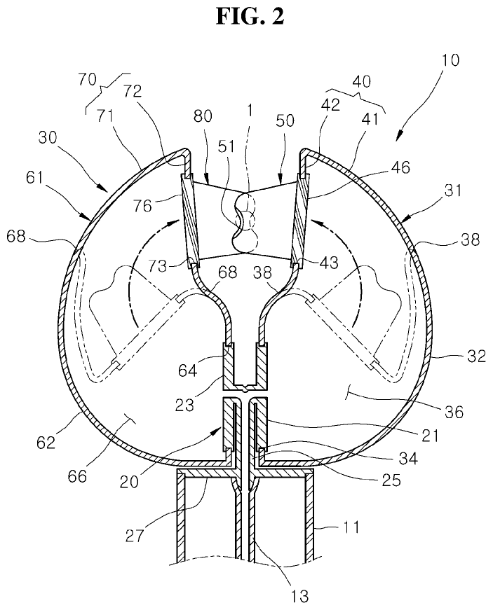

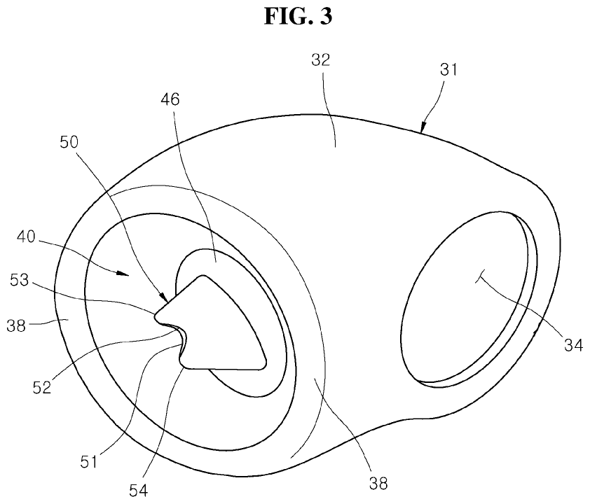

FIGS. 1 and 2 are cross-sectional views of a pneumatic cutter with a concealed blade according to a first embodiment of the present disclosure, wherein FIG. 1 is a view illustrating a state in which the blade is concealed, and FIG. 2 is a view illustrating a state in which the blade protrudes, and FIG. 3 is a perspective view illustrating one pouch illustrated in FIG. 1 and the blade fixed thereto. Referring to FIGS. 1 to 3, a pneumatic cutter 30 with a concealed blade according to the first embodiment of the present disclosure may be included in a cutting robot 10. The cutting robot 10 includes a robot arm 11 having an end portion at which the pneumatic cutter 30 with a concealed blade is installed. Since the robot arm 11 includes a plurality of joints (not illustrated) and the position and angle of the end portion may be changed, the position and angle of the pneumatic cutter 30 with a concealed blade that is installed at the end portion of the robot arm 11 are also adjusted to facilitate cutting of an object to be cut 1.

The pneumatic cutter 30 with a concealed blade includes first and second pouches 31 and 61, first and second blades 50 and 80, a pneumatic connector 20, a pneumatic tube 13, and a pneumatic pump (not illustrated). Inner spaces 36 and 66 filled with air are formed in the first and second pouches 31 and 61, respectively, and the first and second pouches 31 and 61 respectively include fixed shape portions 32 and 62 which are not deformed even upon a pneumatic pressure being applied to inner portions of the pouches 31 and 61 and variable portions 40 and 70 which are configured to, upon the pneumatic pressure being applied to the inner portions of the pouches 31 and 61, protrude outward as the inner spaces 36 and 66 expand and, in a case where the pneumatic pressure is not applied to the inner portions, be concavely recessed inward as the inner spaces 36 and 66 contract.

Pneumatic connector installation through-holes 34 and 64 through which the pneumatic connector 20 is installed are formed in rear end portions of the fixed shape portions 32 and 62. The first and second pouches 31 and 61 further include boundary portions 38 and 68 which are connected to each other and serve as boundaries between the fixed shape portions 32 and 62 and the variable portions 40 and 70. The fixed shape portions 32 and 62 include outer side curved wall portions which are convexly curved and where intervals between the boundary portions 38 and 68 and the pneumatic connector installation through-holes 34 and 64 are relatively large and inner sidewall portions which are provided at opposite sides of the outer side curved wall portions and where the intervals between the boundary portions 38 and 68 and the pneumatic connector installation through-holes 34 and 64 are relatively small The first and second pouches 31 and 61 are disposed so that the pneumatic connector installation through-holes 34 and 64 and the inner sidewall portions face each other.

The variable portions 40 and 70 include curved wall portions 41 and 71 disposed relatively close to the outer side curved wall portions and flat wall portions 42 and 72 disposed relatively close to the inner sidewall portions. One side ends of the curved wall portions 41 and 71 and one side ends of the flat wall portions 42 and 72 are connected in a sealed manner to the fixed shape portions 32 and 62 through the boundary portions 38 and 68, and the other side ends of the curved wall portions 41 and 71 and the other side ends of the flat wall portions 42 and 72 are connected in a sealed manner to each other.

The first and second pouches 31 and 61 may be made of an elastomer and may be formed by vulcanization molding in which a liquid rubber material is injected into a mold and vulcanized. The first and second pouches 31 and 61 may be made of silicone rubber.

The first and second blades 50 and 80 are installed at the flat wall portions 42 and 72 of the variable portions 40 and 70 via first and second blade support members 46 and 76. In more detail, blade installation through-holes 43 and 73 are formed in the flat wall portions 42 and 72. The first and second blades 50 and 80 are fixed to and supported by the first and second blade support members 46 and 76, and the first and second blade support members 46 and 76 seal and close the blade installation through-holes 43 and 73 and are installed to be fixed to the blade installation through-holes 43 and 73.

The first and second blades 50 and 80 are installed at the first and second pouches 31 and 61 so that the first and second blades 50 and 80 lie down instead of standing upright, in other words, thickness directions thereof are parallel to the vertical direction. The first and second blades 50 and 80 are installed with a slight height difference to closely pass by and rub against each other, instead of colliding with each other, when approaching each other and then overlap each other.

As illustrated in FIG. 1, in a state in which a pneumatic pressure is not applied to the first and second pouches 31 and 61 and thus the variable portions 40 and 70 are concavely recessed, ends of the first and second blades 50 and 80 do not protrude outward past the boundary portions 38 and 68 between the variable portions 40 and 70 and the fixed shape portions 32 and 62. Accordingly, while the pneumatic cutter 30 with a concealed blade approaches the object to be cut 1, the first and second blades 50 and 80 do not touch the object to be cut 1 and damage the object to be cut 1. Since the first and second pouches 31 and 61 are made of an elastic flexible material, such as an elastomer, as described above, even when the first and second pouches 31 and 61 touch the object to be cut 1 while the pneumatic cutter 30 with a concealed blade approaches the object to be cut 1, the object to be cut 1 is not damaged, and an accident of a worker is also prevented.

When the pneumatic cutter 30 with a concealed blade is moved close to the object to be cut 1 so that the object to be cut 1 is positioned at a front center of the first and second pouches 31 and 61, and a pneumatic pressure is simultaneously applied to inner portions of the first and second pouches 31 and 61, the inner spaces 36 and 66 of the first and second pouches 31 and 61 simultaneously expand, and the variable portions 40 and 70 protrude outward, specifically, forward, as shown by solid lines in FIG. 2.

Here, the flat wall portions 42 and 72 of the variable portions 40 and 70 rotate to become closer to each other about inner side portions of the boundary portions 38 and 68 that are connected to the inner sidewall portions of the fixed shape portions 32 and 62. Accordingly, like the flat wall portions 42 and 72, the first and second blades 50 and 80 installed to be fixed to the flat wall portions 42 and 72 also move along curved paths indicated by one-dot chain arrows in FIG. 2 to protrude toward the object to be cut 1 and cut the object to be cut 1. Also, the ends of the first and second blades 50 and 80 protrude outward past the boundary portions 38 and 68 between the variable portions 40 and 70 and the fixed shape portions 32 and 62. In more detail, the first and second blades 50 and 80 overlap each other and cut the object to be cut 1 by a shear force.

In a case where the pneumatic pressure is not applied to the inner portions of the first and second pouches 31 and 61, in other words, the pneumatic pump (not illustrated) configured to supply the pneumatic pressure to the inner portions of the first and second pouches 31 and 61 does not operate, in a state in which the variable portions 40 and 70 are protruding, the first and second pouches 31 and 61 are elastically restored to the state of FIG. 1 so that the variable portions 40 and 70 move rearward into the fixed shape portions 32 and 62 and become concavely recessed. Although not clearly illustrated in FIGS. 1 and 2, a thickness of the variable portions 40 and 70 may be less than a thickness of the fixed shape portions 32 and 62. In particular, since the curved wall portions 41 and 71 are excessively bent and then straightened in the process in which the variable portions 40 and 70 protrude outward and are recessed inward, for smooth deformation of the curved wall portions 41 and 71, a thickness of the curved wall portions 41 and 71 may be less than the thickness of the fixed shape portions 32 and 62.

The first and second blades 50 and 80 include, at end portions thereof, concave groove portions 51 and 81 which are concavely recessed inward, that is, toward the blade support members 46 and 76. Outer protrusion portions 53 and 83 and inner protrusion portions 54 and 84 are provided at both sides of the concave groove portions 51 and 81 to limit the concave groove portions 51 and 81, and sharp edges 52 and 82 are formed on the concave groove portions 51 and 81. Accordingly, when the pneumatic pressure is simultaneously applied to the inner portions of the first and second pouches 31 and 61 and thus the first and second blades 50 and 80 move along the curved paths to approach the object to be cut 1, unless the object to be cut 1 deviates from the concave groove portions 51 and 81, the object to be cut 1 may move to the deepest points of the concave groove portions 51 and 81, and a cutting surface of the object to be cut 1 may be smoothly cut by the edges 52 and 82.

Sharp edges may not be formed on corners other than the concave groove portions 51 and 81 in the first and second blades 50 and 80. In particular, the edges may not be formed on outer corners of the outer protrusion portions 53 and 83. This is because, in a case where the edges are formed on the outer corners of the outer protrusion portions 53 and 83, the edges on the outer corners of the outer protrusion portions 53 and 83 may pierce or cut the curved wall portions 41 and 71 and cause damage thereto when the variable portions 40 and 70 are recessed into the fixed shape portions 32 and 62. Meanwhile, the blades 50 and 80 illustrated in FIGS. 1 to 3 are merely examples of the blade included in the present disclosure, and the pneumatic cutter with a concealed blade of the present disclosure may include blades of various shapes other than those illustrated.

The object to be cut 1 may be a fruit connected to a branch or stalk through a fruit stem, such as an apple, a strawberry, or a peach or may be a fruit vegetable connected to a stalk through a fruit stem, such as a pepper, an eggplant, a tomato, or a cucumber. Specifically, the pneumatic cutter 30 with a concealed blade may be used to cut a fruit stem and separate and harvest a fruit or fruit vegetable from a branch or stalk.

The pneumatic pump (not illustrated) is a device configured to selectively provide a pneumatic pressure to the first and second pouches 31 and 61 and is disposed outside the robot arm 11. The pneumatic connector 20 includes first and second pouch fixing portions 21 and 23 configured to seal and close the pneumatic connector installation through-holes 34 and 64 of the first and second pouches 31 and 61 and be installed to be fixed to the pneumatic connector installation through-holes 34 and 64, a flange portion 27 extending to be coupled to an end of the robot arm 11, and a flow path extending portion 25 which has a front end portion connected to the first and second pouch fixing portions 21 and 23, a rear end portion connected to the flange portion 27, and a flow path formed therein to allow air to flow.

The pneumatic tube 13 is a tube in which a flow path is formed to allow air to flow. A front end portion of the pneumatic tube 13 is fluidly connected to the rear end portion of the flow path extending portion 25, and a rear end portion of the pneumatic tube 13 is fluidly connected to the pneumatic pump. The pneumatic tube 13 may extend through the robot arm 11. By such a configuration, when the pneumatic pump operates, the variable portions 40 and 70 of the first and second pouches 31 and 61 and the first and second blades 50 and 80 installed thereon protrude and cut the object to be cut 1, and when the pneumatic pump stops, the variable portions 40 and 70 are elastically restored and thus the first and second blades 50 and 80 return to positions where the first and second blades 50 and 80 are recessed into the fixed shape portions 32 and 62. The cutting robot 10 including the pneumatic cutter 30 and the robot arm 11 may automatically move along a programmed path and harvest a fruit or fruit vegetable without intervention of a worker.

Meanwhile, although the pneumatic cutter 30 with a concealed blade that is illustrated in FIGS. 1 and 2 includes the pair of pouches 31 and 61 facing each other and the pair of blades 50 and 80 respectively installed in the pouches 31 and 61, a pneumatic cutter with a concealed blade according to a modification of the present disclosure may include a single pouch including a pair of variable portions and a pair of blades respectively installed on the pair of variable portions. In this case, upon a pneumatic pressure being applied to an inner portion of the pouch while an object to be cut is positioned in front of the pouch and between the pair of variable portions, the pair of blades may move along a curved path in directions approaching each other to overlap each other and cut the object to be cut by a shear force.

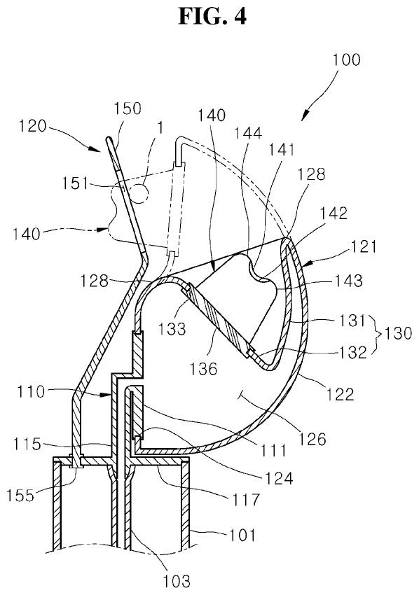

FIG. 4 is a cross-sectional view of a pneumatic cutter with a concealed blade according to a second embodiment of the present disclosure. Referring to FIG. 4, a pneumatic cutter 120 with a concealed blade according to the second embodiment of the present disclosure may be included in a cutting robot 100. The cutting robot 100 includes a robot arm 101 having an end portion at which the pneumatic cutter 120 with a concealed blade is installed. The pneumatic cutter 120 with a concealed blade includes a pouch 121, a blade 140, a cutting guide 150, a pneumatic connector 110, a pneumatic tube 103, and a pneumatic pump (not illustrated). An inner space 126 filled with air is formed in the pouch 121, and the pouch 121 includes a fixed shape portion 122 which is not deformed even upon a pneumatic pressure being applied to an inner portions of the pouch 121 and a variable portions 130 which is configured to, upon the pneumatic pressure being applied to the inner portion of the pouch 121, protrude outward as the inner space 126 expands and, in a case where the pneumatic pressure is not applied to the inner portion, be concavely recessed inward as the inner space 126 contracts.

A pneumatic connector installation through-hole 124 through which the pneumatic connector 110 is installed is formed in a rear end portion of the fixed shape portion 122. The pouch 121 further includes a boundary portion 128 which serves as a boundary between the fixed shape portion 122 and the variable portion 130. The fixed shape portion 122 includes an outer side curved wall portion which is convexly curved and where an interval between the boundary portion 128 and the pneumatic connector installation through-hole 124 is relatively large and an inner sidewall portion which is provided at the opposite side of the outer side curved wall portion and where the interval between the boundary portion 128 and the pneumatic connector installation through-hole 124 is relatively small.

The variable portion 130 includes a curved wall portion 131 disposed relatively close to the outer side curved wall portion and a flat wall portions 132 disposed relatively close to the inner sidewall portion. The pouch 121 may be made of an elastomer, more specifically, silicone rubber. The blade 140 is installed at the flat wall portion 132 of the variable portions 130 via a blade support member 136. In more detail, a blade installation through-hole 133 is formed in the flat wall portions 132. The blade 140 is fixed to and supported by the blade support member 136, and the blade support member 136 seals and closes the blade installation through-hole 133 and is installed to be fixed to the blade installation through-hole 133.

The blade 140 is installed at the pouch 121 so that the blade 140 lies down instead of standing upright, in other words, a thickness direction thereof is parallel to the vertical direction. In a state in which a pneumatic pressure is not applied to the pouch 121 and thus the variable portion 130 is concavely recessed as shown by solid lines in FIG. 4, an end of the blade 140 does not protrude outward past the boundary portion 128 between the variable portion 130 and the fixed shape portion 122. Accordingly, while the pneumatic cutter 120 with a concealed blade approaches the object to be cut 1, the blade 140 does not touch the object to be cut 1 and damage the object to be cut 1. Also, since the pouch 121 is made of an elastic flexible material such as an elastomer, even when the pouch 121 touches the object to be cut 1 while the pneumatic cutter 120 with a concealed blade approaches the object to be cut 1, the object to be cut 1 is not damaged, and an accident of a worker is also prevented.

The cutting guide 150 is disposed to be spaced apart from the variable portion 130 protruding outward due to the pneumatic pressure being applied to the pouch 121. The cutting guide 150 may have a rear end portion 155 fixed to and supported by a flange portion 117 of the pneumatic connector 110. However, as long as a front end portion of the cutting guide 150 can be spaced apart at a predetermined interval from the pouch 121, the cutting guide 150 may be fixed to and supported by the robot arm 101 or another unillustrated member, unlike FIG. 4.

For an end portion of the blade 140 to be inserted into the cutting guide 150 instead of colliding therewith when the blade 140 protrudes as shown by a two-dot chain line in FIG. 4 due to the pneumatic pressure being applied to the pouch 121, a cut slit 151 may be formed in the cutting guide 150. Upon the pneumatic pressure being applied to the inner portion of the pouch 121 while the object to be cut 1 is positioned between the cutting guide 150 and the variable portion 130 as shown by a one-dot chain line in FIG. 4, the blade 140 moves along a curved path toward the cutting guide 150 and cuts the object to be cut 1. Here, since the object to be cut 1 is supported by the cutting guide 150 so as not to be able to avoid the blade 140, cutting can be reliably performed. Since, as described above, the end portion of the blade 140 which has cut the object to be cut 1 is inserted into the slit 151 instead of colliding with the cutting guide 150, damage to the blade 140 and the cutting guide 150 is prevented.

In a case where the pneumatic pressure is not applied to the inner portion of the pouch 121, in other words, the pneumatic pump (not illustrated) configured to supply the pneumatic pressure to the inner portion of the pouch 121 does not operate, in a state in which the variable portion 130 is protruding, the pouch 121 is elastically restored to the state shown by solid lines in FIG. 4 so that the variable portion 130 moves rearward into the fixed shape portion 122 and becomes concavely recessed.

Like the blades 50 and 80 included in the first embodiment of the present disclosure, the blade 140 included in the second embodiment of the present disclosure includes, at an end portion thereof, a concave groove portion 141 which is concavely recessed inward, that is, toward the blade support member 136. An outer protrusion portion 143 and an inner protrusion portions 144 are provided at both sides of the concave groove portion 141 to limit the concave groove portion 141, and a sharp edge 142 is formed on the concave groove portion 141.

A sharp edge may not be formed on corners other than the concave groove portion 141 in the blade 140. In particular, the edge may not be formed on an outer corner of the outer protrusion portion 143. This is because, in a case where the edge is formed on the outer corner of the outer protrusion portion 143, the edge on the outer corner of the outer protrusion portions 143 may pierce or cut the curved wall portion 131 and cause damage thereto when the variable portion 130 is recessed into the fixed shape portions 122.

In a pneumatic cutter with a concealed blade of the present disclosure, the blade is concealed so as not to protrude to an outside of a pouch and then protrudes to the outside of the pouch to accurately cut an object to be cut. Therefore, the blade does not touch an object to be cut and cause damage thereto while the pneumatic cutter approaches the object to be cut. Also, since the pouch is made of an elastic flexible material, even when the pouch touches an object to be cut while the pneumatic cutter of the present disclosure approaches the object to be cut, the object to be cut is not damaged, and an accident of a worker is also prevented.

Even when crops such as fruits or fruit vegetables are automatically harvested using a cutting robot including the pneumatic cutter of the present disclosure and a robot arm configured to support the pneumatic cutter, damage to the crops is suppressed, and the marketability of the crops is not reduced. Therefore, the efficiency of crop harvesting can be improved, an unmanned system for crop harvesting can be promoted, and costs of crop production can be reduced by saving labor costs.

The present disclosure has been described above with reference to the embodiments illustrated in the drawings, but the description is merely illustrative, and those of ordinary skill in the art should understand that various modifications and other equivalent embodiments are possible therefrom. Therefore, the true protection scope of the present disclosure should be defined only by the appended claims.

What is claimed is:

1. A pneumatic cutter with a concealed blade, the pneumatic cutter comprising:
a pouch in which an inner space filled with air is formed and which includes a variable portion configured to, upon a pneumatic pressure being applied to an inner portion of the pouch, protrude outward as the inner space expands and, in a case where the pneumatic pressure is not applied to the inner portion of the pouch, be concavely recessed inward as the inner space contracts; and
a blade installed at the variable portion and configured to, upon the variable portion protruding outward due to the pneumatic pressure being applied to the inner portion of the pouch, protrude toward an object to be cut and cut the object to be cut.

2. The pneumatic cutter of claim 1, further comprising a fixed shape portion which is not deformed even upon the pneumatic pressure being applied to the inner portion of the pouch,
wherein, in a state in which the variable portion is concavely recessed, an end of the blade does not protrude outward past a boundary portion between the variable portion and the fixed shape portion.

3. The pneumatic cutter of claim 2, wherein, while the variable portion protrudes outward, the blade moves along a curved path, and the end of the blade protrudes outward past the boundary portion between the variable portion and the fixed shape portion.

4. The pneumatic cutter of claim 1, wherein, in a case where the pneumatic pressure is not applied to the inner portion of the pouch in a state in which the variable portion is protruding outward, the pouch is elastically restored so that the variable portion is concavely recessed inward.

5. The pneumatic cutter of claim 1, wherein the pouch is made of an elastomer.

6. The pneumatic cutter of claim 1, wherein:
the pouch is provided as a pair of pouches that face each other;
the pair of pouches each include the variable portion;
the blade is installed at each of the pair of variable portions; and
upon a pneumatic pressure being simultaneously applied to inner portions of the pair of pouches while the object to be cut is positioned at a front center of the pair of pouches disposed to face each other, the pair of blades overlap each other and cut the object to be cut by a shear force.

7. The pneumatic cutter of claim 1, wherein:
the pouch includes the variable portion as a pair of variable portions;
the blade is installed at each of the pair of variable portions; and
upon a pneumatic pressure being applied to the inner portion of the pouch while the object to be cut is positioned in front of the pouch and between the pair of variable portions, the pair of blades move along a curved path in directions approaching each other to overlap each other and cut the object to be cut by a shear force.

8. The pneumatic cutter of claim 1, further comprising a cutting guide spaced apart from the variable portion so as not to come in contact with the variable portion protruding outward,
wherein, upon a pneumatic pressure being applied to the inner portion of the pouch while the object to be cut is positioned between the cutting guide and the variable portion, the blade moves toward the cutting guide and cuts the object to be cut.

9. The pneumatic cutter of claim 1, wherein:
the blade includes, at an end portion, a concave groove portion which is concavely recessed inward; and
a sharp edge is formed on the concave groove portion.

10. The pneumatic cutter of claim 1, wherein the object to be cut is a fruit or fruit vegetable.
